(19) United States
(12) Patent Application Publication
(10) Pub. No.: US 2006/0127598 A1
(43) Pub. Date: Jun. 15, 2006

(54) Method for providing a coating on the surfaces of a product with an open cell structure throughout its structure and use of such a method

(76) Inventors: Marc Pauwels, Gent (BE); Anthony Vanlandeghem, Oudenaarde (BE); Johan Palmers, Amougies (BE)

Correspondence Address: James C Wray, Suite 300, 1493 Chain Bridge Road, McLean, VA, 22101, US

(21) Appl. No.: 10/537,659

(22) PCT Filed: Jan. 30, 2003
(86) PCT No.: PCT/EP03/00949

§ 371 Date: Jun. 6, 2005

(51) Int. Cl. H05H 1/24

(52) U.S. Cl. 427/569

(57) ABSTRACT

The invention relates on the one hand to a method for providing a coating on the surfaces of a product with an open cell structure throughout its structure, in which said coating is provided by means of a plasma polymerisation process. The foam has to be prepared for the plasma polymerisation processes in respect to the specific process. Polymerisation is performed inside the open and semi-open cell structures in a qualitative and homogenious way. On the other hand, the invention relates to the use of a method as described above as a hydrophone, oleophobe, flame retardant and/or barrier coating on the surfaces of an open cell polymer throughout its polymer structure.

The invention relates on the one hand to a method for providing a coating on the surfaces of a product with an open cell structure throughout its structure. On the other hand, the invention relates to the use of such a method as a hydrophobe, oleophobe, flame retardant and/or barrier coating on the surfaces of an open cell polymer throughout its polymer structure.

In order to provide certain characteristics such as fire and flame retardant, water-repellent, etc, to products with an open cell structure, for instance foams, different methods are used.

On the one hand, it is known to perform this by means of chemical plunging (also called impregnation with a wet chemical product), for example as described in U.S. Pat. No. 3,950,298, in which the material such as textile materials which has to be made water-repellent is completely drenched with an organic solution of a water-repellent additive so that the water-repellent additive is widely spread onto the inner surface of the textile material and exceeding additive is squeezed out.

The disadvantage of such a method is that the product has to be dried very intensively, which requires a lot of time and energy.

On the other hand, in order to provide abovementioned characteristics, a process can be used as described in WO01/00718, in which a bonded foam comprising a plurality of isocyanate-based polymeric foam particles, in particular polyurethane foam particles, bonded to one another by means of an isocyanate based binder and a process for the production thereof is described. In order to make this bonded foam water-repellent, at least one water-repellent additive is incorporated into the bonded foam. By incorporating a water-repellent additive therein, a bonded foam is obtained which is usually still quite hydrophilic, but which has a water uptake which is reduced to maximum 500 g/m³, and preferably of maximum 180 g/m³ (determined at 25° C. in accordance with the French standard UEAtc H.1 MOD1). The water-repellent additive may be incorporated into the bonded foam once it has been demoulded or once it has been cut further into pieces of the desired dimensions. Further ways to incorporate the water-repellent additive are:
by admixing it to the binder before applying this binder to the foam particles;
in case the water-repellent additive is in liquid form, by spraying it onto the foam particles, more particularly before or after applying the binder to these particles and/or even simultaneously thereto; and
in case the water-repellent additive is in solid form, by mixing it with the foam particles, preferably before having applied the binder thereto so that a homogeneous mixture can more easily obtained.

The problem of such a process for making bonded foams is that it is a very complicated process.

The purpose of the invention is to provide a method for providing a coating on the surfaces of a product with an open cell structure throughout its structure, which is performed in a more easy way, for example in a dry, more economical and environmental friendly way.

The purpose of the invention is achieved by providing a method for providing a coating on the surfaces of a product with an open cell structure throughout its structure, in which said coating is provided by means of a plasma polymerisation process.

Plasma polymerisation is a process by which a thin layer of polymeric film is deposited on any surface which is in contact with the plasma of the organic monomer. Depending on the deposition conditions, referred to as the plasma parameters e.g. power, pressure, flow rate, etc., the properties of the film can be adapted to the requirements.

The film is formed from polymerisable species originated from a plasma-forming gas. The starting material monomers introduced in gasform in the plasma, ionises, which results in energetic species, such as electrons, ions or photons, in the gas phase, consequently effecting the breaking of chemical bonds and thus creating free radicals, that then are absorbed by the surface of the substrate, and bond together and polymerise.

Notwithstanding the fact that there is an existing prejudice in the technical field by the man skilled in the art that it is impossible to provide a coating on the surface of a product with an open cell structure throughout its structure by means of a plasma polymerisation process, the method according to the invention provides in a satisfying product.

In a preferred method according to the invention, said product with an open cell structure is degassed before performing the plasma polymerisation process.

Using such a method gives the advantage that no liquids are used, and accordingly the process is performed in a dry manner. Furthermore, there is no waste because this kind of process works with low amounts of gas, as consumable. No further chemicals like solvents or water are used or contaminated in this process.

Foams have to be prepared (structure must be open, rest solvents and humidity evacuated, sealing foils removed) to allow the free radicals which are formed during the polymerisation process (as described above), to penetrate deep enough in the open cell structure of the product.

The preparation is preferably exerted by means of drying the open cell polymer in a drying kiln.

A second possibility is that the evacuation is exerted within the plasma polymerisation coating device.

Said degassing is preferably exerted by a temperature between 20° C. and 200° C.

In a preferred method according to the invention, the plasma polymer process is performed in a vacuum.

For creating the free radicals, preferably a monomer vapour is used in the plasma polymer process.

Said monomer vapour consists preferably of a monomer or a mixture of monomers containing halogen and/or phosphor and/or nitrogen and/or silicon.

The monomer(s) can first of all result from precursor gas(es) or liquid(s) selected from fluor containing compounds and/or phosphor containing compounds and/or silicon containing compounds and/or nitrogen containing compounds.

Second of all, the monomer(s) can result from precursor(s) selected from CF₄, C₂F₆, C₃F₆, C₃F₈, C₄F₈, C₅F₁₂ and/or C₆F₁₄ or other saturated or unsaturated fluorocarbons (CₓF_{y}) or hydrofluorcarbons.

Third of all, the monomer(s) can result from precursor(s) selected from trimethylphosphate, triethylphosphate, tripropylphosphate or other derivates of phosphoric acid.

Finally, the monomer(s) can result from precursor(s) selected from ethylamine, triethylamine, allylamine or acrylonitrile.

In a preferred method according to the invention, said product with an open cell structure is an open cell polymer.

In a more preferred method according to the invention, said open cell polymer is a polyurethane, a polyethylene, a melamine or a polystyrene foam.

In an other preferred method according to the invention, said product with an open cell structure is a sintered open-cell reticulated/foam-like structure.

Said sintered open-cell reticulated/foam-like structures are preferably made out of pure metals, alloys or ceramics.

In still another method according to the invention, said open cell structure is a semi-open cell foam.

Said semi-open celled foam is preferably an urethane, a polyethylene or a polystyrene semi-open cell foam.

In order to provide certain characteristics such as fire and flame retardant, hydrophobic, oleophobic, barrier coated, etc, to products with an open cell structure, for instance foams, throughout the open cell structure of the product, in the method according to the invention a plasma polymerisation process is used. Examples of products which are treated by means of such a method are airplane seats, isolation materials for transport vehicles and construction purposes, etc.

The problem which arises when using plasma polymerisation in a product with an open cell structure is that there in such products, gasses are present. In this way, the free radicals which are formed during the plasma polymerisation process can't penetrate deep enough in the open cell structure. This problem is solved by degassing the products with an open cell structure by means of drying it in a drying kiln by a temperature between 20° C. to 200° C. The drying can also be performed immediately in the plasma polymerisation device.

The plasma polymerisation process takes place in a plasma vacuum reactor. For performing a plasma polymerisation process, a number of determining parameters has to be considered, i.e.
power;
type of monomer vapour, gas flow;
working pressure;
frequency op plasma generator (40 kHz, 13,56 MHz, 2,45 GHz, standard or pulsed);
process time.

The plasma can be initiated on different ways, i.e. radiofrequency, pulse or DC, and the number and placement of electrodes can also vary.

The pump down is depending on the pump and volume of the reactor that is used. Evacuation is necessary in order to keep a very low pressure or vacuum in the reactor chamber. This is to be able to do the polymerisation process.

For obtaining free radicals in the reactor chamber, the monomers of the monomer vapour react with energetic species, such as electrons, ions or photons. Therefore, a high power is needed, which results in a high diffraction of the monomers. For instance, on lab scale, depending on the size of the reactor, a power between 50 and 300 Watt is used. When the reactor chamber is under a low pressure or vacuum, the radicals have less chance to collide with other radicals and accordingly have a greater chance to attain the product with an open cell structure.

In this plasma polymerisation process, different types of monomer vapours can be used. Said monomer vapour consists of a monomer or a mixture of monomers containing halogen and/or phosphor and/or nitrogen and/or silicon.

The monomer(s) can result from precursor gas(es) or liquid(s) selected from fluor containing compounds and/or phosphor containing compounds and/or silicon containing compounds and/or nitrogen containing compounds;

Furthermore, the monomer(s) can result from precursors selected from:
CF₄, C₂F₆, C₃F₆, C₃F₈, C₄F₈, C₅F₁₂ and/or C₆F₁₄ or other saturated or unsaturated fluorcarbons (CₓF_{y}) or hydrofluorcarbons;
trimethylphosphate, triethylphosphate, tripropylphosphate or other derivates of phosphoric acid;
ethylainine, triethylamine, allylamine or acrylonitrile.

Different products with open cell structures can be treated with this methods, i.e.:
an open cell polymer such as a polyurethane, a polyethylene, a melamine or a polystyrene foam;
a sintered open-cell reticulated/foam-like structure, for instance made out of pure metals, alloys or ceramics;
a semi-open celled foam, such as an urethane, a polyethylene or a polystyrene semi-open celled foam.

The method according to the invention and as described above is used for providing a hydrophobe, oleophobe, flame retardant and/or barrier coating on the surfaces of an open cell polymer throughout its polymer structure.

Further features and specific aspects of the invention, as well as the use thereof, will become apparent from the following example, describing a preferred embodiment of the invention in more detail. It should be observed that the specific aspects of this example is only set forth as an explanation of what is meant in the context of the above general disclosure of the invention, and should not be interpreted as a limitation of the scope of the invention as such and as expressed in the claims and the end of this specification.

### EXAMPLE

### Plasma Polymerisation on the Surface and Throughout the Structure of a Foam to Give Hydrophobic Characteristics to a Melamine Foam

The melamine foam is placed in a CD1000, which is a system made by Europlasma N.V., Oudenaarde, Belgium. The CD1000 is being sucked out and heated (to accelerate the degassing of the foam) to the basic pressure. The parameters which are provided in the reactor chamber are the following:
power: 0-1000 W
working pressure: 20-500 mtorr
electrode: 2 electrodes

In the reactor chamber of the CD1000, a gas is introduced, whereafter polymerisation is able to start. The process time which is applied with a foam with a thickness of 100 mm is between 10min-1 hour. This treatment protects the melamine foam from taking up water.

The hydrophobic characteristics of this treated melamine foam is measured by means of the following method: IPA (isopropylalcohol), which is strongly hydrophilic and which penetrates deep into a product, is put onto the product in a dissolved way. To reach a certain level, the solution has to remain on the product for 10 seconds. The different levels which determine the water-repellence are:

| Level | % IPA | % demineralised H₂O |
|---|---|---|
| 1 | 2 | 98 |
| 2 | 5 | 95 |
| 3 | 10 | 90 |
| 4 | 20 | 80 |
| 5 | 30 | 70 |
| 6 | 40 | 60 |

The melamine foam treated by the method as described above reaches level 6.

This melamine foams can be used for isolation for instance in airplanes, studio's, houses, etc, for seats, children's mattresses, etc to prevent taking water up. When such seats are placed in places with a highly relative moisture content, they do not take up moisture. In children's mattresses, it is in such a way prevented that moisture penetrates into the mattress.

1. Method for providing a coating on the surfaces of a product with an open cell structure throughout its structure, wherein said coating is provided by means of a plasma polymerisation process, characterised in that said product with an open cell structure is degassed before performing the plasma polymerisation process.

2. Method according to claim 1, characterised in that the degassing is exerted by means of drying the open cell polymer in a drying kiln.

3. Method according to claim 1, characterised in that the degassing is exerted within the plasma polymerisation device.

4. Method according to claim 2, characterised in that said degassing is exerted by a temperature between 20° C. and 200° C.

5. Method according to claim 1, characterised in that the plasma polymer process is performed in a vacuum.

6. Method according to claim 1, characterised in that in the plasma polymer process a monomer vapour is used.

7. Method according to claim 6, characterised in that said monomer vapour consists of a monomer or a mixture of monomers containing halogen and/or phosphor and/or nitrogen and/or silicon.

8. Method according to claim 7, characterised in that the monomer(s) result from precursor gas(es) or liquid(s) selected from fluor containing compounds and/or phosphor containing compounds and/or silicon containing compounds and/or nitrogen containing compounds.

9. Method according to claim 8, characterised in that the monomer(s) result from precursor(s) selected from CF₄, C₂F₆, C₃F₆, C₃F₈, C₄F₈, C₅F₁₂ and/or C₆F₁₄ or unsaturated fluorcarbons (CₓF_{y}) or hydrofluorcarbons.

10. Method according to claim 8, characterised in that the monomer(s) result from precursor(s) selected from trimethylphosphate, triethylphosphate, tripropylphosphate or other derivates of phosphoric acid.

11. Method according to claim 8, characterised in that the monomer(s) result from precursor(s) selected from ethylamine, triethylamine, allylamine or acrylonitrile.

12. Method according to claim 1, characterised in that said product with an open cell structure is an open cell polymer.

13. Method according to claim 12, characterised in that said open cell polymer is a polyurethane, a polyethylene, a melamine or a polystyrene foam.

14. Method according to claim 1, characterised in that said product with an open cell structure is a sintered open-cell reticulated/foam-like structure.

15. Method according to claim 14, characterised in that said sintered open-cell reticulated/foam-like structures are made out of pure metals, alloys or ceramics.

16. Method according to claim 1, characterised in that open cell structure is a semi-open celled foam.

17. Method according to claim 16, characterised in that said semi-open celled foam is an urethane, a polyethylene or a polystyrene semi-open celled foam.

18. Use of a method according to claim 1 with the goal to obtain a hydrophobe, oleophobe, flame retardant and/or barrier coating on the surfaces of an open cell polymer throughout its polymer structure.
